(19) United States
(12) Patent Application Publication
(10) Pub. No.: US 2025/0363843 A1
(43) Pub. Date: Nov. 27, 2025

(54) Method and Device for Securely Sharing a Digital Key for a Vehicle

(71) Applicant: Bayerische Motoren Werke Aktiengesellschaft, Muenchen (DE)

(72) Inventor: Matthias FINK, Muenchen (DE)

(21) Appl. No.: 19/179,336

(22) Filed: Apr. 15, 2025

(30) Foreign Application Priority Data
May 24, 2024 (DE) 10 2024 114 670.2

(51) Int. Cl. G07C 9/00; H04W 4/40

(52) U.S. Cl. CPC G07C 9/00309; H04W 4/40; G07C 2009/00341; G07C 2009/0042; G07C 2009/00507; G07C 2009/00769; G07C 2009/00865

(57) ABSTRACT

A user device of a user of a service for the provision of a vehicle is described, wherein the user device is set up to send first device-specific information of the user device to the backend unit during a sharing process for a digital verification key as part of a registration for the service. The user device is further set up to send second device-specific information of the user device to the back-end unit for using the service during a sharing process for a digital use key, wherein the second device-specific information and the first device-specific information are the same.

### CROSS REFERENCE TO RELATED APPLICATION

This application claims priority under 35 U.S.C. § 119 from German Patent Application No. 10 2024 114 670.2, filed May 24, 2024, the entire disclosure of which is herein expressly incorporated by reference.

### BACKGROUND AND SUMMARY OF THE INVENTION

The invention relates to methods and corresponding devices for sharing a digital key for a (motor) vehicle.

A vehicle may have one or more functions that can be controlled by a user of the vehicle using an electronic device, such as a smartphone. The electronic device has a digital key that is checked by the vehicle to authenticate the electronic device and to enable the control of one or more vehicle functions following the authentication of the electronic device.

Examples of vehicle functions include opening or unlocking and/or closing or locking a door or flap of the vehicle, and/or starting the drive motor of the vehicle. The authentication of the digital key and/or the control of the one or more vehicle functions is typically carried out via a wireless communication link, in particular via a BLE (Bluetooth Low Energy) communication link and/or via a Near Field Communication (NFC) communication link, between the vehicle and the electronic (key) device.

It may be desired by a service provider for a vehicle-related service (e.g., a car-sharing service) to provide a user with a digital (use) key for a vehicle. This document deals with the technical object of enabling convenient and secure sharing of a digital key for a vehicle.

The object is achieved by each of the independent claims. Advantageous embodiments are described in the dependent claims, among other places. It should be noted that additional features of a claim dependent on an independent claim without the features of the independent claim, may constitute a separate invention independent of the combination of all the features of the independent claim or only in combination with a subset of the features of the independent claim, which has been made the subject of an independent claim, a division application or a subsequent application. This applies in the same way to technical teachings described in the description, which may constitute an invention independent of the features of the independent claims.

According to one aspect, a (mobile and/or portable) user device (e.g., a smart device and/or a smartphone) is described. The user device may enable a user to use a service to provide a (motor) vehicle. For this purpose, the user device may have a software application running on the user device that is set up to communicate with a back-end unit (e.g., a server) of the service provider. The communication can take place via a (possibly wireless) communication link. The user device may also have a secure memory unit, especially in a secure element, for storing data.

The user device is set up to send registration data of the user to the back-end unit of the service for the purpose of creating a user profile as part of a registration for the service. The registration data may concern, for example: the name and/or address of the user; a means of payment of the user; etc.

Furthermore, the user device is set up to carry out a sharing process for a digital verification key with the back-end unit. The digital verification key can be designed according to the Car Connectivity Consortium, CCC, key standard, in particular according to CCC Release 3. Furthermore, the sharing process can be carried out according to the CCC key standard.

The user device can also be set up to send first device-specific information of the user device to the back-end unit as part of the sharing process for the verification key. In particular, the user device can be set up to read the first device-specific information from the secure memory unit, in particular from the secure element, of the user device and then send it to the back-end unit. The first device-specific information can include, for example,
an instance CA according to the CCC key standard; and/or
an AccountIDHash according to the CCC key standard.

It should be noted that in the CCC key standard, in particular in a future version of the CCC key standard, one or more other data elements may be used and/or defined that are suitable as device-specific information (and which are provided to the backend unit during a sharing process). For example, in V4 of the CCC key standard, an AccountInfoHash is introduced. The (first) device-specific information can include this AccountInfoHash, for example.

The first device-specific information can be stored in the backend unit together with and/or in association with the user profile of the user. The first device-specific information can be designed in such a way that the user device of the user is identified (if necessary, unambiguously) by the first device-specific information. The first device-specific information determined during registration and stored (in the back-end unit) can be used to reliably limit the provision of a digital use key for a vehicle to the authorized user device. On the other hand, the provision of a digital use key to another (unauthorized) user device can be reliably prevented.

The user device can be set up to sign the registration data with the verification key as part of the registration for the service to determine a verification signature. Furthermore, the user device can be set up to send the verification signature to the back-end unit via the communication link. The user can be asked to authenticate himself (for example, by entering a password or by facial or fingerprint recognition) via a user interface of the user device. As part of the sharing process for the verification key, the user may have been provided with a second factor (e.g., a PIN). The second factor may have been provided via a different transmission channel than the sharing URL for the verification key. The user may be asked to authenticate themself with the second factor (the PIN).

The verification signature can (if necessary, only) be determined in response to a successful authentication of the user and can be sent to the backend unit. By providing a signature, the authenticity of the registration data (and the user) can be reliably verified.

The user device can be set up to receive a message from the back-end unit to the effect that the verification key has been revoked as part of the registration for the service. In response, the verification key can be deleted, especially from the secure memory unit of the user device. Alternatively or in addition, registration for the service may be terminated and/or completed. In this way, a particularly secure registration can be achieved.

The verification key preferably does not have any authorizations to control one or more vehicle functions of (any) vehicle. In this way, a particularly secure registration for a vehicle-related service can be achieved.

The user device can be set up to send a request to the backend unit to provide a digital use key for a vehicle to use the service. The request may be associated with the user profile of the user (for example, by providing the name and/or identifier of the user within the request).

The user device can also be set up to carry out (at least partially) a sharing process for the digital use key with the backend unit. The digital use key and/or the sharing process can each be designed in accordance with the CCC key standard, in particular according to CCC Release 3. The digital use key can have an authorization to control one or more vehicle functions of the vehicle. If appropriate, only part of the sharing process is carried out.

As part of the sharing process for the digital use key, second device-specific information of the user device can be sent to the backend unit via the communication link. The user device can be set up to read the second device-specific information from the secure memory unit, especially from the secure element, of the user device and then send it to the back-end unit. The second device-specific information can include, for example, an instance CA according to the CCC key standard; and/or an AccountIDHash according to the CCC key standard.

The second device-specific information is preferably the same as the first device-specific information. As a result it is reliably and securely indicated to the backend server that the user device requesting the digital use key is the same user device that was used for registration. Thus a particularly secure sharing of a digital use key can be enabled.

According to another aspect, a backend unit (for example a computing unit, such as a server) for a service for the provision of a (motor) vehicle is described. The backend unit is set up to receive user registration data from a first user device of the user for the purpose of creating a user profile and for carrying out a sharing process (according to the CCC key standard) for a digital verification key (according to the CCC key standard) with the first user device. As part of the sharing process for the verification key, first device-specific information of the first user device can be received via the communication link, wherein the first device-specific information can be stored in association and/or together with the user profile (in a memory unit of the back-end unit).

The backend unit can be set up to receive a verification signature for the registration data from the first user device as part of the registration for the service. The registration data can then be verified using the verification signature and the verification key. If appropriate, the registration data and/or the first device-specific information will only be included in the user profile after a successful verification. Particularly secure registration can thus be carried out.

The backend unit can be set up to send a message to the first user device indicating that the verification key has been revoked as part of the registration for the service. This allows the registration to be concluded in a reliable manner.

The back-end unit is preferably set up to ensure that no certificate is sent to the vehicle for the verification key. A particularly efficient registration can thus be achieved.

The backend unit may also be set up to receive a request from a second user device with reference to the stored user profile (of the user) to provide a digital use key for a vehicle for use of the service by a user. For example, the request can specify the username and/or user ID of the user of the first user device. The second and first user devices can be identical or different. The measures described in this document make it possible to reliably detect a second user device that does not correspond to the first user device.

Furthermore, the backend unit can be set up to carry out (at least partially) a sharing process for the digital use key with the second user device, and to receive second device-specific information of the second user device from the second user device as part of the sharing process for the digital use key.

The second device-specific information can be compared with the first device-specific information of the stored user profile. In addition, the digital use key can be provided to the second user device via the communication link depending on the comparison. In particular, the back-end unit may be set up to provide the digital use key to the second user device (only) if the second device-specific information and the first device-specific information are the same and/or identical. In this case, the back-end unit may also be set up to cause a certificate for the use key to be sent to the vehicle, wherein the certification enables the vehicle to verify the use key. In particular, the certificate may include data that makes it possible to provide the digital use key to the vehicle. The data contained in the certificate can enable the vehicle to check the authenticity of the digital use key.

Alternatively or in addition, the back-end unit can be set up to prevent the provision of the digital use key to the second user device if the second device-specific information differs from the first device-specific information.

A digital use key can thus be shared securely as part of a vehicle-related service.

The sharing process for a digital key (for example, for the verification key or for the use key) can include sending a sharing URL (Uniform Resource Locator) from the backend unit to the user device. The user device can then call up the sharing URL to initiate the provision of the key. In each case, device-specific information can be sent from the user device to the backend unit.

According to another aspect a (road) motor vehicle (a passenger car or a truck or a bus or a motorcycle) is described that contains one or more of the devices described in this document.

According to an aspect, a method for enabling a service for the provision of a (motor) vehicle is described. The method may include, as part of a registration for the service, sending registration data of a user via a communication link to a back-end unit of the service for the purpose of creating a user profile; carrying out a sharing process for a digital verification key with the back-end unit; and sending, as part of the sharing process for the verification key, first device-specific information of the user device via the communication link to the back-end unit.

Further, the method for using the service may include sending a request to provide a digital use key for a vehicle to the back-end unit; carrying out a sharing process for the digital use key with the backend unit; and sending, as part of the sharing process for the digital use key, second device-specific information of the user device to the back-end unit via the communication link.

According to another aspect, a method for enabling a service to provide a (motor) vehicle is described. The method may include, as part of registering for the service, receiving registration data of a user via a communication link from a first user device for the purpose of creating a user profile; carrying out a sharing process for a digital verification key with the first user device; receiving, as part of the sharing process for the verification key, first device-specific information of the first user device via the communication link; and the storage of the first device-specific information in association with the user profile.

Furthermore, the method for using the service may include receiving a request from a second user device related to the stored user profile to provide a digital use key for a vehicle; carrying out a sharing process for the digital use key with the second user device; receiving, as part of the sharing process for the digital use key, second device-specific information of the second user device via the communication link from the second user device; comparing the second device-specific information with the first device-specific information of the stored user profile; and providing the digital use key to the second user device depending on the comparison.

According to another aspect, a software (SW) program is described. The SW program can be set up to be run on a processor and thereby to carry out one or more of the methods described in this document.

According to another aspect, a non-transitory memory medium is described.

The memory medium may contain a SW program that is set up to be run on a processor and thereby carry out one or more of the methods described in this document.

It should be noted that the methods, devices and systems described in this document may be used alone and in combination with other methods, devices and systems described in this document. In addition, any aspect of the methods, devices and systems described in this document can be combined with each other in a variety of ways. In particular, the features of the claims can be combined with each other in a variety of ways. In addition, features listed in brackets are to be understood as optional features.

In the following, the invention is described in more detail using exemplary embodiments. In the figures,

### BRIEF DESCRIPTION OF THE DRAWINGS

FIG. 1a shows an exemplary digital access system of a vehicle;

FIG. 1b shows an exemplary key device;

FIG. 1c shows an example of sequential transfer of digital keys;

FIG. 1d shows an exemplary sequence of digital keys and corresponding certificates;

FIG. 2a shows an exemplary user device and an exemplary backend unit;

FIG. 2b shows exemplary actions during registration for a vehicle-related service;

FIG. 2c shows exemplary actions when using a vehicle-related service;

FIG. 3 shows a flow chart of an exemplary method for enabling a vehicle-related service; and

FIG. 4 shows a flow chart of another exemplary method for enabling a vehicle-related service.

### DETAILED DESCRIPTION OF THE DRAWINGS

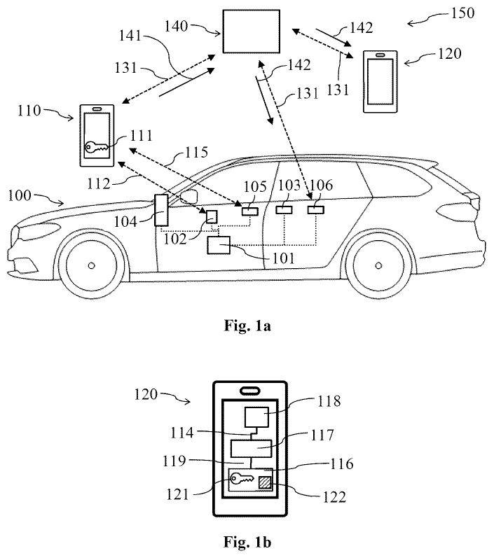

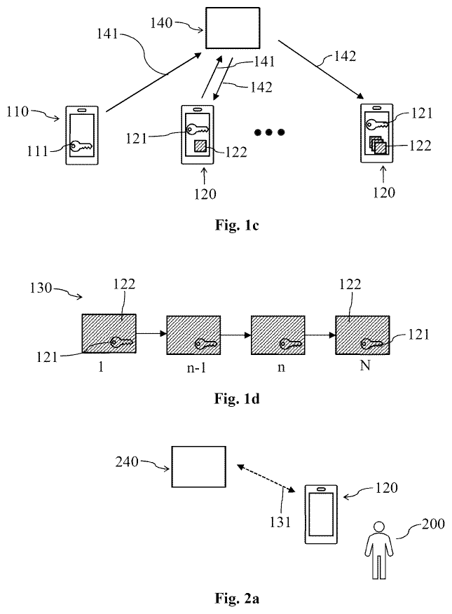

As explained at the outset, this document deals with being able to share a digital key for a vehicle with another user in a convenient and secure way. In this context, FIG. 1a shows an exemplary (access) system 150, which comprises at least one vehicle 100 and a digital key device 110. The digital key device 110 is typically a portable electronic device, such as a smartphone or a tablet PC, with a digital key 111 stored on the portable electronic device. The identity of the digital key 111, can be stored in a protected memory area, in particular in a so-called “secure element”, of the portable electronic device (such as the user device).

The digital key device 110 is designed to communicate with a communication unit 102, 105 of the vehicle 100 via one or more different wireless communication links 112, 115. Example communication links 112, 115 are a Bluetooth Low Energy (BLE) communication link 112 and/or a Near Field Communication (NFC) communication link 115.

The system 150 also comprises a central unit 140, for example a back-end unit or a back-end server, which is set up to communicate in each case via a wireless communication link 131 (for example, via a 3G, 4G, 5G communication link) with the digital key device 110 and/or with the vehicle 100 (a communication unit 106 of the vehicle 100).

A (control) device 101 of the vehicle 100 may be designed to control at least one vehicle function 103 of the vehicle 100 depending on the communication between the device 110 and the vehicle 100. In this context, the digital key 111 of the device 110 can be verified, in particular authenticated. In addition, after successful authentication, one or more vehicle functions 103 can be controlled, depending on
the distance between the device 110 and the vehicle 100;
the location of the device 110 relative to the vehicle 100; and/or
a control command sent from the device 110 to the vehicle 100 via a communication link 112, 115.

The scope of the one or more vehicle functions 103 that can be controlled by the key device 110 may depend on one or more characteristics of the digital key 111. It may be possible to enable one or more vehicle functions 103 and/or to block one or more vehicle functions 103 using the digital key 111.

The user of the key device 111 may be enabled to make it possible for another user and/or another electronic device 120 to control one or more vehicle functions 103. For this purpose, the key device 111 may arrange for a digital key to be provided to the other electronic device 120, which may determine the scope of the one or more vehicle functions 103 that can be controlled by the other electronic device 120.

The key device 110 can send a transfer request 141 to the central unit 140 via the communication link 131, which is aimed at causing the central unit 140 to pass on a digital key to another device 120. The transfer request 141 can be signed with the digital key 111 of the key device 110. Furthermore, the transfer request 141 can specify the range of functions of the key to be passed on, if appropriate.

The central unit 140 can then generate a digital key for the other electronic device 120. This digital key can be passed on together with a certificate for this digital key to the vehicle 100 and to the other electronic device 120 (in corresponding messages 142). The certificate can be used by the vehicle 100 to check the authenticity of the digital key for the other electronic device 120. For this purpose, the vehicle 100 requires the digital key 111 of the key device 110 by which the transfer of a digital key was initiated. Furthermore, the central key of the central unit 140 with which the certificate for the digital key for the further electronic device 120 was signed is typically required.

For example, an asymmetric method can be used for encryption (such as elliptic curve cryptography (ECC)). The public part of a key can be used to verify a digital key in the vehicle 100 (for example, the public part of the central key and/or the public part of the respective digital key).

FIG. 1b shows details of the further electronic device 120. In particular, FIG. 1b shows the secure memory area 116, in particular the so-called “secure element”, in which the digital key 121 provided to the electronic device 120 and, if applicable, the certificate 122 of this digital key 121 are stored. The certificate 122 can alternatively be stored in another (non-secure) memory area, since the certificate 122 is already protected (by the signature with the preceding key 111, 121 and by the signature with the central key of the central unit 140).

The memory area 116 can be read by the operating system and/or by a control device 117 of the device 120 via a (secure) data interface 119. In addition, the operating system and/or the control device 117 can pass on data from the memory area 116, for example the digital key 121 and/or the certificate 122, via another data interface 114 to a software application 118 of the device 120.

Typically, the digital key 121 (along with other metadata) is contained in the certificate 122, so only the certificate 122 is provided (within the message 142) to the vehicle 100 and/or the electronic device 120. From this certificate 122, the digital key 121 can be extracted (using the (public part of) the central key of the central unit 140 and/or the (public part of) the key 111, 121 from which the digital key 121 was derived).

The certificate 122 for the digital key 121 can have two parts. In a first part, the digital key 121 can be described (this can be data stored in plain text and signed by the digital key 111, which shares the digital key 121, such as the public key, entitlements (such as the permissions of the digital key 121), etc.). The second part can be attached by the central unit 140 and can include metadata related to the digital key 121.

The user of the device 120 can be enabled to arrange for a digital key to be passed on to another device 120, as shown by way of example in FIG. 1c. The other device 120 can then be provided with a digital key 121 and an associated certificate 122 (each in a message 142). Thus, a sequence, in particular a chain 130, of digital keys 121 can be sequentially constructed, wherein the individual keys 121 are each associated with a certificate 122 (as shown as an example in FIG. 1d). The sequence 130 of digital keys 121 shown in FIG. 1d comprises a total of N keys 121, which follow each other sequentially from n=1 to n=N. The Nth key 121 in the sequence 130 of keys 121 can be described as the target key of the last device 120 in the sequence of devices 120.

It may happen that the digital key 111 is to be shared with another user across platforms. This can be done by providing the device 120 of the other user with a sharing URL for a digital key 121 and a second factor (in particular, a PIN). The sharing URL and the second factor can be provided to the other device 120 via a communication application (for example, a messenger service, email, etc.). Different transmission channels should be chosen for the sharing URL and for the second factor. If an inexperienced user chooses the same transmission channel for the sharing URL and for the second factor, a malicious third party can be able to carry out key sharing with their own device and effectively gain access to the vehicle 100. Typically, the actual share destination (i.e., the device 120 for which key sharing is intended) cannot be explicitly specified.

The transfer of a digital key 111 from one user to another user typically implies that there is a certain level of trust between the two users, for example, directly from the vehicle owner to the key recipient or indirectly to another recipient via the key recipient (i.e., along a chain of trust). If a digital key 111 is to be shared by a service (e.g., a car-sharing service) on a back-end server, the recipient group is so large that there is typically no relationship of trust and/or personal connection between the vehicle owner and the respective recipient. It is typically not possible for a user who wants to book and use a vehicle 100 (for example, a vehicle of a car-sharing service) to identify themselves with a suitable crypto key.

The measures described in this document aim to limit the target of a key sharing to a single user and/or to a single device 120 when a digital key 121 is released by a backend service. The key is released by means of a sharing URL.

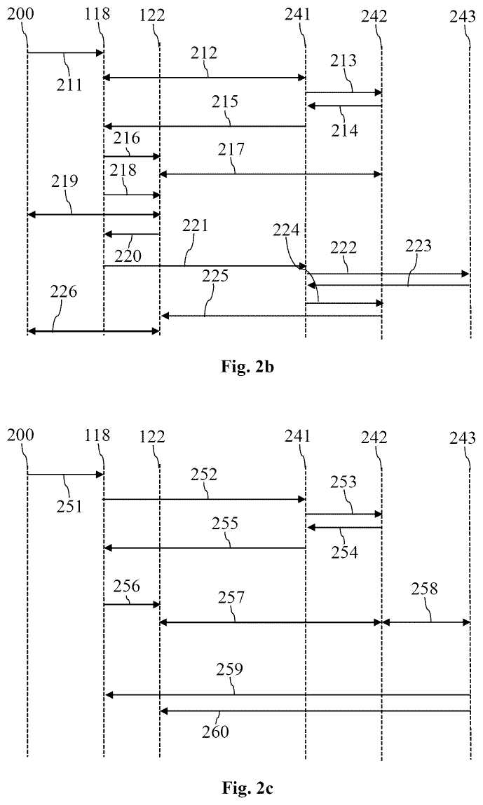

FIG. 2a shows an example back-end unit 240, which is set up, for example, to provide a specific service for the use of one or more vehicles 100. A user 200 can communicate with the back-end unit 240 via a user device 120 (by means of a communication link 131). The user 200 can register with the backend unit 240 via the user device 120. In addition, the user 200 can receive a digital key 121 for the use of a vehicle 100 from the back-end unit 240. A digital key 121 for the use of a vehicle 100 is also referred to as a use key in this document.

FIG. 2b shows a flowchart of an exemplary registration process, and FIG. 2c shows a flowchart of an exemplary process for sharing a digital (use) key 121.

As part of the registration process (see FIG. 2b), the user 200 can initiate (action 211) the registration with the back-end unit 240, with a service module 241 of the back-end unit 240, via a software application 118 of the user device 120. Steps for registration (entering user data, etc.) can then be carried out between the software application 118 and the service module 241 (action 212). In addition, a verification key can be generated (action 213, 214) by the back-end unit 240 and provided (action 215) to the software application 118 of the user device 120. For example, the verification key can be requested (action 213) by the service module 241 at a key module 242 of the back-end unit 240, whereupon the verification key is generated and provided by the key module 242 (action 214). A sharing URL for the verification key can be provided. In addition, a second factor for the verification key can be provided to the user 200.

The sharing URL for the verification key can be called up by the software application 118 (Action 216). The verification key can then be shared between the secure memory unit 122 of the user device 120 and the key module 242 of the backend unit 240 and stored in the secure memory unit 122 of the user device 120 (action 217). For this purpose, the method specified in the CCC key standard, in particular according to CCC Release 3, can be used.

The verification key can be a digital key according to the CCC key standard. The verification key preferably does not have any rights in relation to the control of a vehicle 100. The certificate generated for the verification key is preferably not sent to the vehicle 100 because the verification key is not provided for controlling vehicle functions 103.

As part of the provision of the verification key, device-specific information (of the user device 120) is typically provided to the back-end unit 240. The device-specific information can include, for example, the instance CA specified in the CCC key standard, which is generated by the secure memory unit 122 of the user device 120. Alternatively or in addition, the device-specific information can include the so-called user account information, which is referred to as AccountIDHash in the CCC key standard. The device-specific information can be designed to identify the user device 120 (unambiguously, if appropriate).

The device-specific information obtained from the back-end unit 240 as part of the sharing process for the verification key can be verified in a subsequent sharing process for the digital (use) key 121 for controlling one or more vehicle functions 103 to ensure that the digital key 121 is requested by the correct and/or by an authorized user device 120.

In the following, it can be checked whether the verification key has actually been stored in the secure memory unit 122 of the user device 120. Alternatively or additionally, the authenticity of the registration data of the user 200 can be verified using the verification key. For this purpose, the software application 118 can send a request to sign the verification data to the secure memory unit 122 (Action 216). In this context, the user 200 can be requested to authenticate themself for the signing of the verification data (for example, by entering a password) (action 219). For this purpose, the second factor of the check key provided by the backend unit 240 can be used. The verification data may include, for example, data from the registration process, in particular the registration data. Following successful authentication, the verification data can be signed with the verification key and the signature can be transmitted to the software application 118 (Action 220).

The software application 118 can then send the signed verification data to the service module 241 of the backend unit 240 (action 221). It can then be checked based on the signature whether the verification data (especially the registration data) are correct. In this context, the signature can be verified (actions 222, 223) using the verification key (which is stored in a management module 243 of the backend unit 240). Furthermore, the device-specific information (from the sharing process for the verification key) can now be stored in the user profile of the user 200 (so that the device-specific information can be used for a subsequent sharing process for the digital (use) key 121).

The verification key can then be revoked (actions 224, 225) and the registration process can be terminated (action 226).

FIG. 2c shows exemplary actions of a subsequent sharing process to provide a digital (use) key 121 for the control of one or more vehicle functions 103. The user 200 can request the provision of the digital key 121 from the software application 118 (action 251). The software application 118 can then send a request to provide the digital key 121 to the back-end unit 240, in particular to the service module 241 of the back-end unit 240 (action 252). The request can refer to the user profile of the user 200 (for example, by specifying the user ID of the user 200).

The service module 241 can then read the (previously stored) device-specific information from the user profile. In addition, the key module 242 can be requested to create a sharing URL for the digital (use) key 121 (Action 253), which is then provided (Action 254). The sharing URL for the digital key 121 can be transmitted to the software application 118 (action 255).

The sharing URL can be requested by means of the software application 118 (Action 256), which results in the execution of the sharing process for providing the digital key 121 (Actions 257, 258). The method specified in the CCC key standard, in particular according to CCC Release 3, can be used for the sharing process. Device-specific information of the user device 120 can be determined, by means of which the digital key 121 is requested.

It can be checked whether the device-specific information of the sharing process for the digital key 121 matches the device-specific information obtained (and stored in the user profile) during the sharing process for the verification key. If this is not the case, the sharing process can be aborted (if necessary with a corresponding note to the user 200) (action 259). If, on the other hand, the device-specific information matches, the sharing process can be continued (Action 260). The certificate for the digital key 121 can be provided (and also sent to the vehicle 100).

In this way, it can be reliably and efficiently ensured that a digital (use) key 121 is only provided to a previously registered (trusted) user device 120 and/or user 200.

Thus, during the registration of a user with the backend service (i.e., with a backend unit 240), a key release of a zero-privilege verification key is performed in order to extract device-specific information that can be used to verify the target user and/or the target device 120 in the event of a future key release for a digital (use) key 121. The verification key can be used to sign a server-side challenge (for example, during the registration of the user, wherein the challenge includes for example the registration data), for example, to bind user account information to digital key information.

Thus, during the setup step for a back-end service (for example, a car-sharing service), a back-end unit 240 (for example, a server) can carry out an additional handshake in which the back-end unit 240 shares a verification key with the device 120 of the user, wherein the verification key preferably has no authorizations (to control one or more vehicle functions 103). The key release may be limited to a release to the user device 120, and preferably will not be passed on to the vehicle 100. Furthermore, the verification key is preferably revoked (i.e., deleted) before the key tracking step (i.e., the registration of the verification key in the central unit 140 and the confirmation by the central unit 140 in the form of a certificate).

Device-specific information retrieved from the key release for the verification key (for example, Instance CA and/or user account information) can be connected to and/or associated with the user profile of the user 200. Since the cross-platform key release, as currently defined in the CCC standard, allows any user and/or device to carry out a key release, this can enable the backend unit 240 to check whether the target user and/or the target device for a key release is the original registered recipient or whether the authorized user has forwarded the sharing URL to an (unauthorized) third party. The verification key may be used to sign information (i.e., registration data) from the registration process to link the registration data to the digital key release of the verification key, which is received in the digital key management backend (i.e., in the central unit 140) of the vehicle manufacturer.

In an application example, the user 200 opens the software application 118 (of the service provider, for example, the car sharing app) and then carries out a registration process. During the registration, the backend unit 240 creates a key-sharing URL or a sharing URL for a verification key (which does not have any authorizations to control vehicle functions 103) and forwards the sharing URL to the software application 118 by means of a notification (via the communication link 131). The software application 118 calls up the sharing URL, which initiates the regular CCC key sharing process. As a result, the digital verification key is stored in the secure memory unit 122 of the user device 120. As part of the registration process, the software application 118 can sign registration data with the digital verification key to link the user account for the service to the digital key information. The digital verification key is then revoked by the backend unit 240 when the registration process is completed.

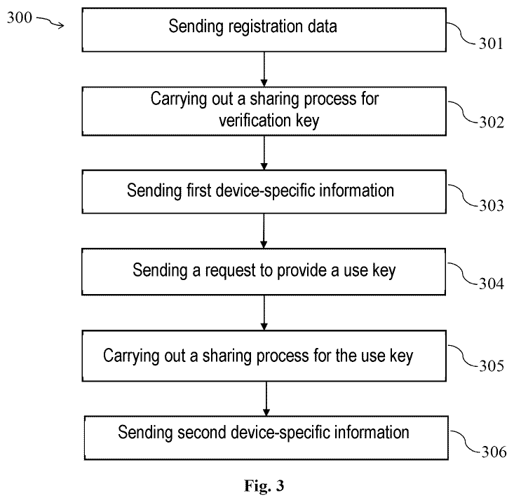

FIG. 3 shows a flow chart of an exemplary (possibly computer-implemented) method 300 for enabling a service to provide a (motor) vehicle 100. The method 300 can be carried out by a user device 120 (a smartphone or a smart device).

The method 300 includes (as part of the registration of a user 200 for the service), sending 301 registration data of the user 200 to a back-end unit 240 (for example, a server) of the service via a communication link 131 for the purpose of creating a user profile. Furthermore, the method 300 includes carrying out 320 a sharing process for a digital verification key (a CCC-based key) with the backend unit 240, as well as sending 303, as part of the (CCC-based) sharing process for the verification key, first device-specific information of the user device 120 via the communication link 131 to the backend unit 240. The first device-specific information can be designed in such a way that the user device 120 can be identified (if necessary, unambiguously) by the first device-specific information.

The method 300 also includes (for the use of the service) sending 304 a request to provide a (CCC-based) digital use key 121 for a vehicle 100 to the back-end unit 240, as well as carrying out 350 a (CCC-based) sharing process for the digital use key 121 with the back-end unit 240. Furthermore, the method 300 includes sending 306, as part of the sharing process for the digital use key 121, second device-specific information of the user device 120 via the communication link 131 to the back-end unit 240. The second device-specific information and the first device-specific information are preferably the same.

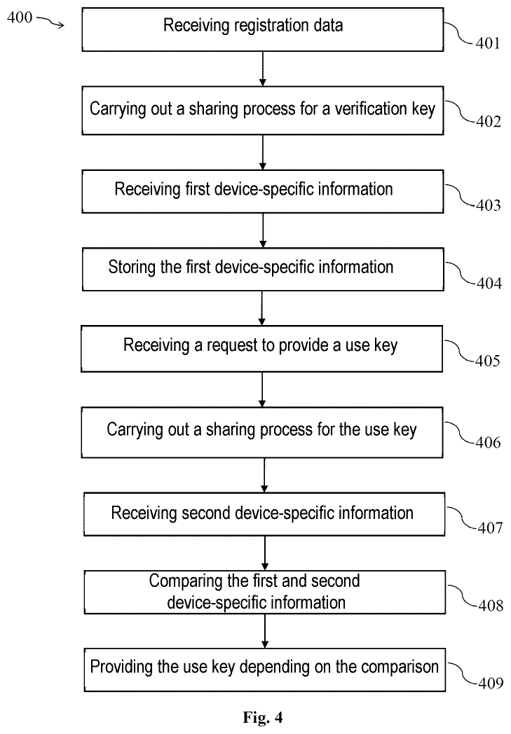

FIG. 4 shows a flow chart of an exemplary (possibly computer-implemented) method 400 for enabling a service to provide a (motor) vehicle 100. The method 400 can be carried out by a backend unit 240 of the service provider.

The method 400 includes (as part of a registration of a user 200 for the service) receiving 401 registration data of the user 200 via a communication link 131 from a first user device 120 for the purpose of creating a user profile. Furthermore, the method 400 includes carrying out 402 a sharing process for a digital verification key with the first user device 120, as well as receiving 403, as part of the sharing process for the verification key, first device-specific information of the first user device 120 via the communication link 131 and storing 404 the first device-specific information in association with the user profile.

The method 400 also includes (for a (subsequent) use of the service) receiving 405 a request with reference to the stored user profile (for example, on behalf of the user 200 of the first user device 120) to provide a digital use key 121 for a vehicle 100 from a second user device 120. The second user device 120 and the first user device 120 can be the same or different. In the context of the method 400, it can be determined whether the second user device 120 corresponds to the first user device 120 (and is therefore authorized for the service) or not (and is therefore not authorized for the service).

Furthermore, the method 400 includes carrying out 406 of a sharing process for the digital use key 121 with the second user device 120. In this case, only part of the sharing process may be carried out (without the digital use key 121 being provided to the second user device 120).

The method 400 also includes receiving 407, as part of the sharing process for the digital use key 121, second device-specific information of the second user device 120 via the communication link 131 from the second user device 120. Furthermore, the method 400 includes comparing 408 the second device-specific information with the first device-specific information of the stored user profile, and providing 409 the digital use key 121 to the second user device 120 depending on the comparison.

Through the measures described in this document, digital keys 121 can also be shared in an efficient and secure manner as part of a vehicle-related service.

The present invention is not limited to the exemplary embodiments shown. In particular, it should be noted that the description and the figures are only intended to illustrate the principle of the proposed methods, devices and systems by way of example.

What is claimed is:

1. A user device of a user of a service for providing a vehicle, wherein the user device is configured to,
as part of registering for the service,
send registration data of the user to a back-end unit of the service via a communication link for the purpose of creating a user profile;
carry out a sharing process for a digital verification key with the backend unit; and
send first device-specific information of the user device to the back-end unit via the communication link as part of the sharing process for the verification key; and
to use the service,
send a request to provide a digital use key for a vehicle to the backend unit;
carry out a sharing process for the digital use key with the backend unit;
send second device-specific information of the user device to the back-end unit via the communication link as part of the sharing process for the digital use key; wherein the second device-specific information and the first device-specific information are the same.

2. The user device according to claim 1, wherein the user device is configured to
read the first and/or the second device-specific information from a secure memory of the user device and then to send it to the back-end unit; and/or
store the verification key and/or the digital use key in the secure memory.

3. The user device according to claim 1, wherein the first and/or the second device-specific information contains at least one of an instance CA according to the CCC key standard and an AccountIDHash according to the CCC key standard.

4. The user device according to claim 1, wherein the digital verification key and the digital use key are both designed according to the Car Connectivity Consortium (CCC) key standard including CCC Release 3.

5. The user device according to claim 1, wherein the user device is configured, in the context of the registration for the service, to
sign the registration data with the verification key to determine a verification signature; and
send the verification signature to the backend unit via the communication link.

6. The user device according to claim 5, wherein the user device is configured to
prompt the user via a user interface of the user device to authenticate themself; and
determine the verification signature in response to a successful authentication of the user.

7. The user device according to claim 1, wherein the user device is configured, in the context of registration for the service, to
receive a message from the back-end unit via the communication link to an effect that the verification key has been revoked; and
in response to a revocation of the verification key to
delete the verification key from the secure memory of the user device; and/or
terminate and/or complete the registration for the service.

8. The user device according to claim 1, wherein
the verification key does not have any authorizations to control one or more vehicle functions of the vehicle; and/or
the digital use key has an authorization to control one or more vehicle functions of the vehicle.

9. A back-end unit for a service to provide a vehicle; wherein the backend unit is configured to,
in a context of a registration for the service,
receive registration data of a user from a first user device of the user for the purpose of creating a user profile via a communication link;
carry out a sharing process for a digital verification key with the first user device;
receive the first device-specific information of the first user device via the communication link as part of the sharing process for the verification key; and
store the first device-specific information in association with the user profile; and
for a use of the service,
receive a request relating to the stored user profile to provide a digital use key for the vehicle from a second user device;
carry out a sharing process for the digital use key with the second user device;
receive second device-specific information of the second user device via the communication link from the second user device as part of the sharing process for the digital use key;
compare the second device-specific information with the first device-specific information of the stored user profile; and
provide the digital use key to the second user device via the communication link depending on the comparison.

10. The back-end unit according to claim 9, wherein the back-end unit is configured to
provide the digital use key to the second user device if the second device-specific information and the first device-specific information are the same; and/or
prevent the provision of the digital use key to the second user device if the second device-specific information differs from the first device-specific information.

11. The back-end unit according to claim 9, wherein the back-end unit is configured, in the context of the registration for the service, to
receive a verification signature for the registration data from the first user device via the communication link; and
verify the registration data using the verification signature and the verification key; wherein the registration data and/or the first device-specific information will only be included in the user profile after a successful verification.

12. The backend unit according to claim 9, wherein the back-end unit is configured, as part of the registration for the service, to send a message to the first user device via the communication link to the effect that the verification key has been revoked.

13. The back-end unit according to claim 9, wherein the back-end unit is configured to
ensure that no certificate is sent to the vehicle for the verification key; and/or
cause a certificate to be sent to the vehicle for the use key; wherein the certification enables the vehicle to verify the use key.

14. A method for enabling a service to provide a vehicle, the method comprising:
in a context of a registration for the service,
sending registration data of a user to a backend unit of the service via a communication link for creating a user profile;
carrying out a sharing process for a digital verification key with the back-end unit; and
sending, as part of the sharing process for the verification key, first device-specific information of the user device to the back-end unit via the communication link; and
in a context of using the service,
sending a request to provide a digital use key for a vehicle to the backend unit;
carrying out a sharing process for a digital use key with the backend unit; and
sending, as part of the sharing process for the digital use key, second device-specific information of the user device to the back-end unit via the communication link; wherein the second device-specific information and the first device-specific information are the same.

15. A method for enabling a service to provide a vehicle, the method comprising:
as part of a registration for the service,
receiving registration data of a user from a first user device via a communication link for creating a user profile;
carrying out a sharing process for a digital use key with the first user device;
receiving, as part of the sharing process for the verification key, first device-specific information of the first user device via the communication link; and
storing the first device-specific information in association with the user profile; and
for a use of the service,
receiving a request relating to the stored user profile to provide the digital use key for the vehicle from a second user device;
carrying out a sharing process for the digital use key with the second user device;
receiving, as part of the sharing process for the digital use key, second device-specific information of the second user device via the communication link from the second user device;
comparing the second device-specific information with the first device-specific information of the stored user profile; and
providing the digital use key to the second user device depending on the comparison.
